(19) United States
(12) Patent Application Publication
(10) Pub. No.: US 2011/0276582 A1
(43) Pub. Date: Nov. 10, 2011

(54) SYSTEMS AND METHODS FOR A JOB AND REFERRAL RECOMMENDATION ENGINE

(76) Inventor: Steven J. Schmitt, Pittsburgh, PA (US)

(21) Appl. No.: 13/100,737

(22) Filed: May 4, 2011

Related U.S. Application Data
(60) Provisional application No. 61/331,371, filed on May 4, 2010.

(51) Int. Cl. G06F 17/30

(52) U.S. Cl. 707/767; 707/E17.137

(57) ABSTRACT

Systems and methods for registering members in a talent management platform, arranging the members in a system network, obtaining profile information from external networks associated with the members, listing open positions, and automatically generating referrals for the open positions using the profile information are described herein.

### CROSS REFERENCE TO RELATED APPLICATION

This application claims the benefit of U.S. Provisional Patent Application Ser. No. 61/331,371, entitled “Systems and Methods for Multi-Level Professional Referral Social Networking,” filed on May 4, 2010, the contents of which are incorporated by reference as if fully set forth herein.

### FIELD OF THE INVENTION

The subject matter presented herein generally relates to Internet-based talent management in relation to professional recruitment and candidate referrals, including automated processes for providing candidate recommendations, and systems and methods therefor.

### BACKGROUND

Employers currently have a limited number of resources for locating candidates for open positions. Typical methods include print advertising and partnering with staffing and recruitment agencies. More recently, a first wave of web sites established the feasibility of utilizing the Internet to post employment positions and search for potential candidates, for example, through online job boards. Among these web sites are resume posting and job search sites, such as MONSTER.COM®. MONSTER.COM is a registered trademark of TMP Worldwide Inc. in the United States and other countries. Although the Internet is now considered a vital job placement resource, online job boards and recruitment sites have long been losing their effectiveness, especially in high demand industries such as information technology and healthcare, and have not adapted to fully realize the potential of recent technological advances.

### BRIEF SUMMARY

In summary, one aspect of the invention provides a system comprising: one or more processors; a system memory operatively coupled to the one or more processors; and one or more professional talent management modules communicatively coupled to the system memory, wherein the one or more professional talent management modules are adapted to: register one or more system members arranged in one or more system networks, each of the one or more members belonging to one or more external networks; obtain network profile information from connections within the one or more system networks and the one or more external networks; list one or more positions comprising position information; and configure a recommendation engine to generate one or more referrals for the one or more positions by applying the network profile information to the position information.

In summary, another aspect of the invention provides a method comprising: registering one or more system members arranged in one or more system networks, each of the one or more members belonging to one or more external networks; obtaining network profile information from connections within the one or more system networks and the one or more external networks; listing one or more positions comprising position information; and configuring a recommendation engine to generate one or more referrals for the one or more positions by applying the network profile information to the position information.

In summary, a further aspect of the invention provides a computer program product comprising: a computer readable storage medium having computer readable program code embodied therewith, the computer readable program code comprising: computer readable program code configured to register one or more system members arranged in one or more system networks, each of the one or more members belonging to one or more external networks; computer readable program code configured to obtain network profile information from connections within the one or more system networks and the one or more external networks; computer readable program code configured to list one or more positions comprising position information; and computer readable program code configured to configure a recommendation engine to generate one or more referrals for the one or more positions by applying the network profile information to the position information.

### BRIEF DESCRIPTION OF THE SEVERAL VIEWS OF THE DRAWINGS

FIG. 1 provides example talent management platform interface according to an embodiment.

FIG. 2 provides an example member network according to an embodiment.

FIG. 3 provides an example multi-level member network according to an embodiment.

FIG. 4 provides an example member network according to one embodiment.

FIG. 5 provides an example of information available to the talent management platform according to an embodiment.

FIG. 6 provides an example recommendation engine accessing a member network according to an embodiment.

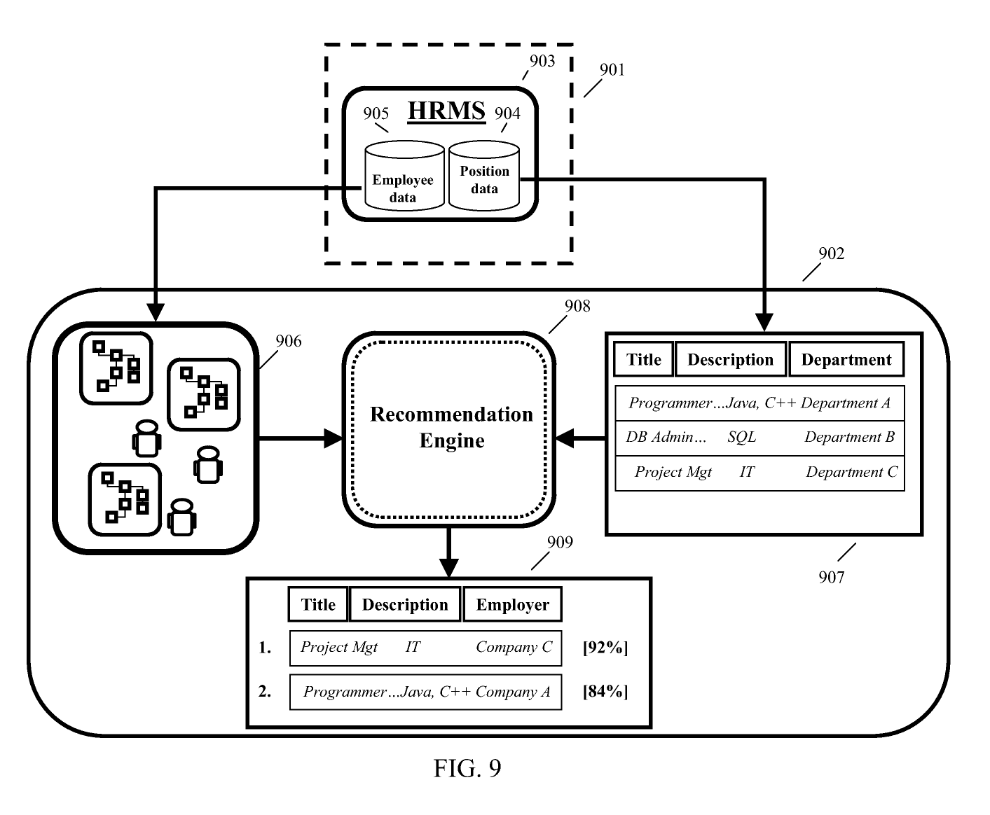

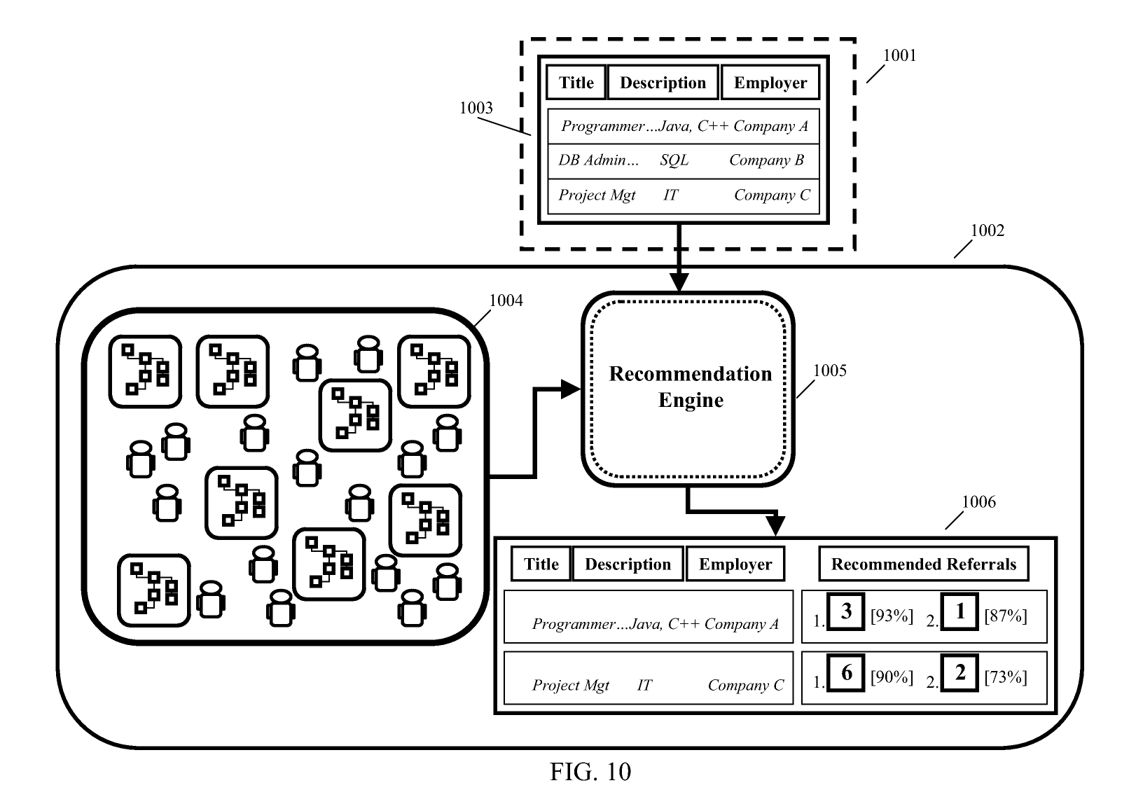

FIG. 5 provides an example of a member interacting with the platform according to an embodiment.

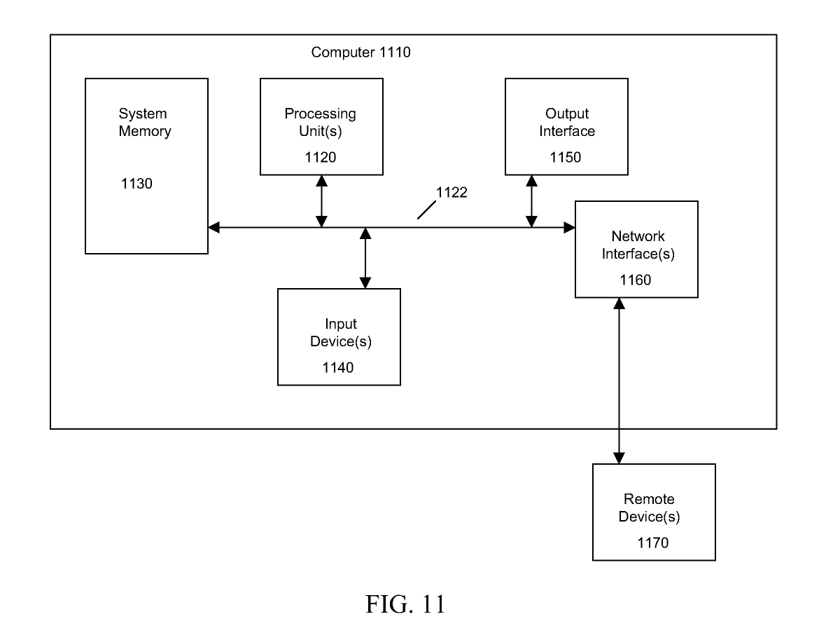

FIG. 6 provides an example recommendation engine accessing a member network and providing position referrals according to an embodiment.

FIG. 7 provides an example of a member interacting with the talent management platform according to an embodiment.

FIG. 8 provides an example of recommendation engine operation with a private network according to an embodiment.

FIG. 9 provides an example of recommendation engine operation with a private network according to an embodiment.

FIG. 10 provides an example of recommendation operation with a staffing firm entity according to an embodiment.

FIG. 11 provides an example computer system.

### DETAILED DESCRIPTION

It will be readily understood that components of the embodiments, as generally described and illustrated in the figures herein, may be arranged and designed in a wide variety of different configurations in addition to the described example embodiments. Thus, the following more detailed description of embodiments, as represented in the figures, is not intended to limit the scope of the invention, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, appearances of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that various embodiments can be practiced without one or more of the specific details, or with other methods, components, materials, et cetera. In other instances, well-known structures, materials, or operations are not shown or described in detail to avoid obfuscation. Throughout this description, example embodiments are described in connection with a computer, such as a desktop, laptop, or notebook computer; however, those skilled in the art will recognize that certain embodiments are equally applicable to other types of electronic devices.

A successful organization today must recruit and retain the best talent to remain competitive. However, there is little alternative but to rely on inefficient conventional methods, such as print advertising and online job boards, or to partner with firms in the professional staffing industry that depend on inefficient tools, technologies, and processes. These firms include staffing, recruiting, headhunting, and consulting firms. Although these professional staffing firms are able to provide some assistance to employers, research suggests they have ultimately created an environment that lacks certain necessary characteristics, such as efficiency, trust, reliability, and accountability.

While endeavoring to recruit and retain talent, human resource (HR) departments are also being faced with several other critical issues, including a massive shortage of skilled professionals, a hyper-competitive business climate, a complicated global workforce, and the increased specialization of labor. These issues are exacerbated in industries where demand for qualified professionals significantly exceeds supply, such as information technology, healthcare, and energy. Accordingly, employers and HR managers, who are often under enormous pressure to attract talent, are seeking innovative, trustworthy, and effective ways to connect with qualified candidates and to maintain current operations in line with their organization's efforts to fuel new growth.

Personal referrals have long been an effective source for obtaining potential candidates for job openings. Referrals are important because they create a connection between the employer and the candidate that an application from an unknown or non-recommended individual simply cannot provide. However, most employers cannot rely on referrals alone because of their personal and incidental nature.

Certain organizations have attempted to create platforms that allow individuals to refer candidates for open positions. For example, an organization may have an internal referral program wherein an employee receives some form of compensation for referring a qualified candidate for an open position or, more commonly, if the referred candidate is hired for the open position. Similarly, certain professional staffing firms may have referral systems wherein individuals outside an organization are compensated for recommending a qualified candidate who ultimately is hired for an open position.

Although such methods potentially provide employers with candidate referrals for open positions, the platforms do not provide processes for effectively recommending candidates beyond basic, conventional matching methods. A common example involves an individual locating a candidate based on an ordinary keyword search that merely matches keywords from a person's profile or resume with a description of an open position. Keyword search and related methods may be able to locate persons with some employment or academic characteristics in common with the position requirements. However, such search results produce a large percentage of false matches, wherein a candidate is actually not a good fit for the position. For example, a candidate may have the required industry experience, but is not interested in leaving his current position, or a candidate may have the appropriate academic background but lacks the necessary employment experience. As such, referral systems according to current methods often overwhelm employers with candidates that are actually not a good fit for, or are not interested in, the position

A highly sought after source of talent is passive job seekers—potential candidates not actively pursuing job opportunities, but may consider a new position if presented with the right situation. These individuals are in demand because they are considered to represent the most talented and productive segments of the workforce. However, these individuals are difficult to locate and present with new opportunities because they are not actively looking for a job. Current job referral methods are not adequately configured to locate passive candidates because these methods do not have the ability to locate such candidates and communicate with them.

Embodiments provide an Internet-based professional talent management platform. More specifically, embodiments provide systems for providing access to professional talent, including, but not limited to, through recruitment and referral systems. For example, embodiments provide systems and methods for the consistent generation of quality referrals to employers. Embodiments described herein are configured to assist individuals, such as hiring managers, find quality employees and/or contractors as efficiently as possible.

Embodiments are configured to implement an Internet-based approach that transforms the traditional, hierarchical staffing model into a model based on an online long-term incentive referral network. Certain embodiments are configured to use a unique business model and software to match demand for qualified employees with a supply of job seekers via the Internet. For example, certain embodiments assist in identifying increased numbers of qualified talent in a more efficient way, transforming conventional talent management approaches.

As such, embodiments provide for a recommendation engine configured to recommend candidates for positions based on certain candidate factors. Illustrative and non-restrictive examples of candidate factors according to embodiments include whether the candidate's background matches the job requirements, how long the candidate has stayed at his current position, and whether the candidate has moved to a higher position each time that he has changed jobs. Accordingly, embodiments are able to recognize the distinctive characteristics of high value candidates for a particular position based on a dynamic set of factors.

In addition, embodiments provide incentives for members and associates of the professional talent management platform to actively participate in the recruitment and referral systems. As a non-limiting example, one embodiment provides that the incentives may consist of certain rewards allocated to platform members for directly or indirectly referring a candidate to an open position posted on the platform. Furthermore, embodiments are configured to generate a system of metrics for referrals made within the talent management platform. According to embodiments, each platform member has a credibility score that represents a measure of the quality of his referrals made within the platform. As a non-limiting example, the quality of the referrals made may be measured according to certain referral characteristics, including, but not limited to, how the referred candidate fits the job requirements or whether the referred candidate actually is interested in the position.

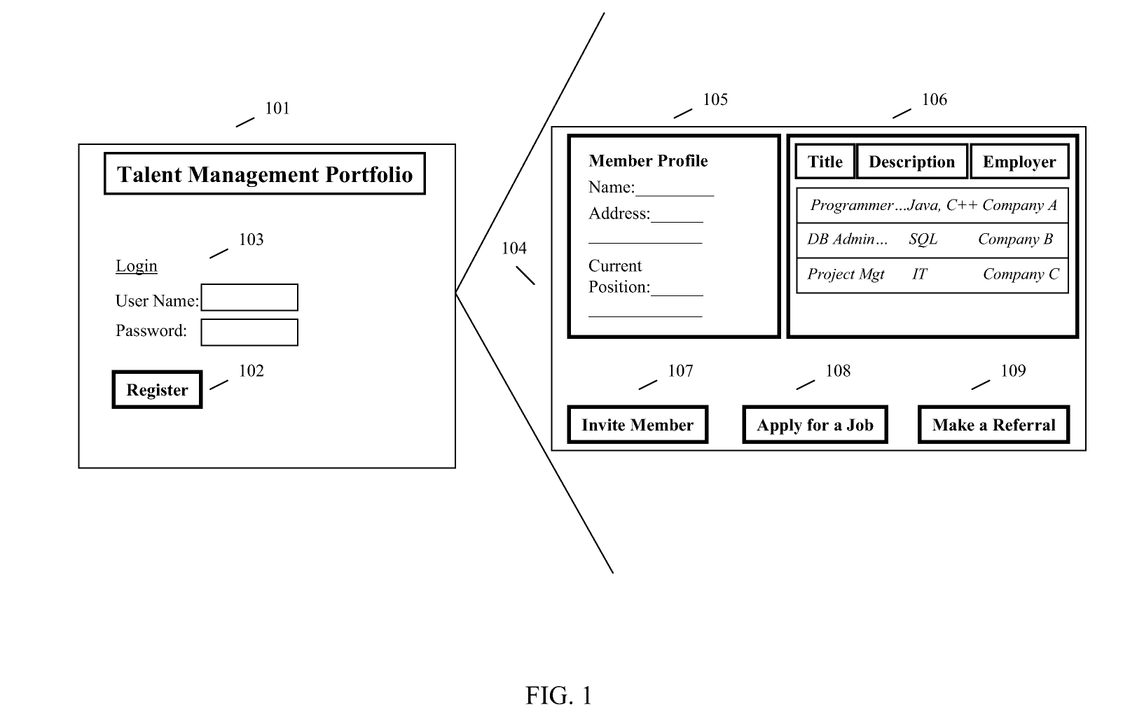

Referring to FIG. 1, therein is depicted an example talent management platform interface according to an embodiment. In the embodiment depicted in FIG. 1, the talent management platform is implemented as an Internet-based service with an interface 101 accessible through a web browser. According to embodiments, individuals register 102 as a new member at the platform web site. As an example member, consider an information technology professional, such as a software engineer, a network engineer, a project manager, a help desk professional, a database analyst, an ERP specialist, a web developer, a graphics designer, or a technical writer. In addition, embodiments provide that the member may take on different roles as part of his or her membership. Illustrative and non-restrictive examples of member roles include seeking full time employment, referring colleagues for open positions (jobs), and acting as a hiring manager or a consultant for one or more companies.

Registration may include choosing a member name and password, filling out a member profile (which can include for example both professional and personal information fields) and saving the membership information. In at least one embodiment, becoming a member and maintaining a membership will not require a fee. In another embodiment, a member may register using credentials from a social networking service, including, but not limited to, LinkedIn® or Facebook®. Facebook is a registered trademark of Facebook, Inc. LinkedIn is a registered trademark of LinkedIn Ltd.

After registering as a platform member, embodiments provide that a user may login 103 to the platform and access certain functions and services 104. For example, the functions and services may be available through a member profile or dashboard interface. As non-limiting examples, functions and services 104 may include creating and editing a member profile 105, viewing posted jobs 106, inviting members to join the platform 107, applying for a job 108, and referring a candidate for a job 109.

After a member has registered, certain embodiments provide that the talent management platform may utilize various methods to verify the member. According to embodiments, verification may be rigorous and may include one or more of the following: credit check(s), drug screening(s), verification of resume information (for example, education and employment information), and requiring direct invitation from an existing member.

Certain embodiments are configured to track a large amount of information regarding members. Such information may include, but is not limited to, social networking site information, including profile and connection information; information resulting from background checks, credit checks, and/or drug screenings; customer ratings; basic demographics; resume information; and member invitation, platform promotional, and job listing procurement information. Such information may be gathered and organized by certain embodiments to form a repository of information regarding a particular member or members. In addition, embodiments may be configured to require such information of the members and that some or all of the information be made accessible, for example, in an effort to create an exclusive set of members, as reflected by the information gathered and made available regarding the members.

Embodiments provide for talent management platform function interfaces that may be accessed from within the talent management platform interface. For example, a community-based user interface modality may be available according to embodiments, which integrates social networking sites, communications modalities (e.g., email and instant messaging), a jobs posting service, as well as various other Web 2.0 capabilities. A credibility score interface may include, but is not limited to, a member rating system, a system providing periodic to continuous feedback for members, and a validity checking system that may conduct and display results relating to various checks, such as credit and criminal background checks. In addition, embodiments provide for one or more interfaces that may include a reserving capability, a recruiting capability, or a retaining capability for members conducting recruiting services. Certain embodiments may further provide a growth interface according to an embodiment that includes, for example, an incentive plan and tracking thereof, a dashboard for hosting widgets, and accounting capabilities.

Embodiments provide for a talent management platform user interface wherein a member may access multiple aspects of the platform from a unified interface. As a non-limiting example, the member may access the interface and view a list of connections, which may comprise platform network connections or external network connections (e.g., social network connections), and associated information. For each connection, a list of jobs wherein the connection may be a quality referral may be listed along with information related to each listed job. As such, a user may view all of his connections and all available jobs where the connection may be a quality referral from a common interface. According to embodiments, the member may select to view all of the available jobs and the interface would display potential referrals derived from the member's connections. In addition, embodiments provide that the member may be able to use the interface to view all available jobs, for example, ranked by how well they fit the member's profile and qualifications.

Embodiments are configured to provide members with opportunities including but not limited to contract assignments, full time jobs, projects, and freelance opportunities. Certain embodiments are configured to reward members for certain services, such as referring another member successfully or building a network from which a qualifying referral is received. According to embodiments, rewards may take various forms, including, but not limited to, increased member ranking, financial or other forms of remuneration, charitable donations, advanced access to job postings, enhanced referral abilities, or some combination thereof. In addition, embodiments are configured to make automated attribution of rewards to members. For example, a member may link a payment account to, or establish an in-house account with, the platform system and receive regular (for example, monthly) distributions of rewards (for example, payments/account deposits) for his or her qualifying events. Furthermore, certain other embodiments provide that members may designate one or more charitable endeavors to receive earned rewards.

Each member may be associated with a network according to embodiments. For example, embodiments provide that a user may invite members to join his network, while other embodiments may leverage social networking web sites to assist members in building a network, as by leveraging a member's existing contacts from other social networking sites as a starting point for identifying candidates for referral.

According to embodiments, if a user registers using social networking credentials, the talent management platform may obtain available social network information, including the profile information of the user's social network contacts. As such, certain embodiments are configured to interface the talent management platform with various other social networking web sites and other web sites to facilitate information retrieval and importation from these other web sites, such as contacts lists, member characteristics, and organization characteristics. The member's network may, for example, comprise a referral network, such that a member may receive a reward when any one in his or her network receives a reward.

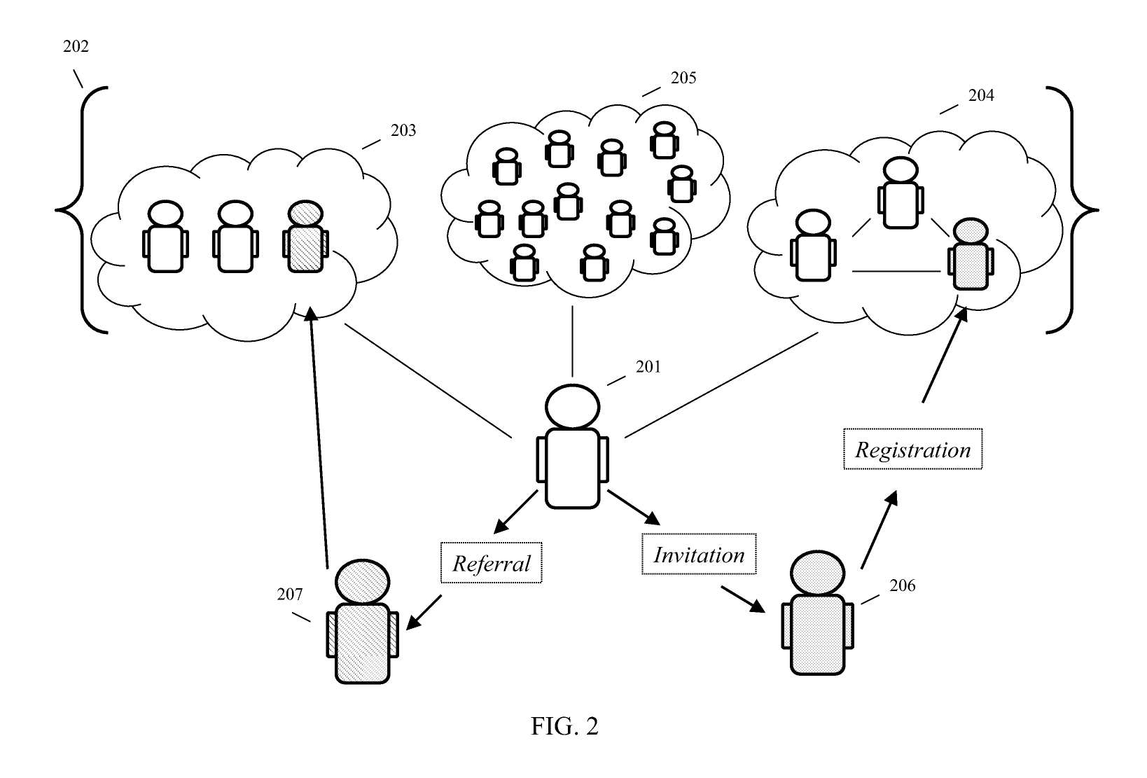

Referring to FIG. 2, therein is depicted an example member network for according to an embodiment. A talent management platform member, Member 1 201 may have a network 202 consisting of connections, including, but not limited to, referral connections 203, member connections 204, and outside network connections 205.

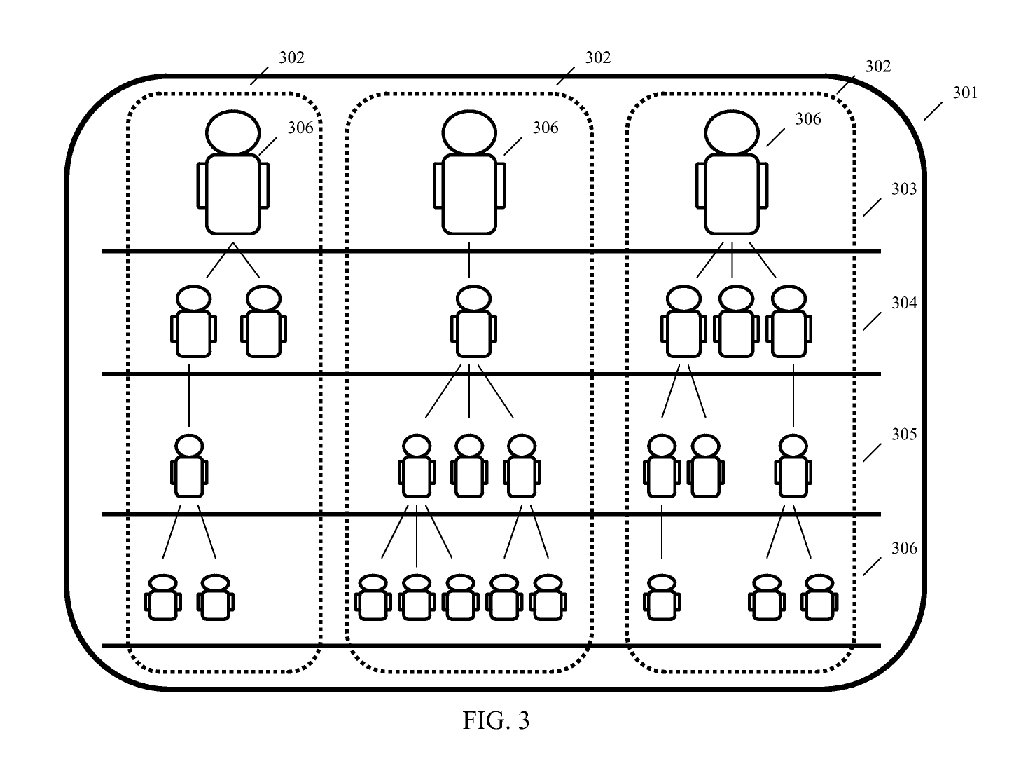

According to embodiments, member connections 204 may consist of platform members in Member 1's 201 network 202. For example, if Member 1 201 invites Member 2 206 to join the talent management platform and Member 2 206 registers with the platform, Member 2 206 is in Member 1's 201 network 202, more specifically, as a member connection 204. In addition, platform members who register responsive to invitations from members in Member 1's 201 network 202 become a part of Member 1's 201 network 202, for a certain number of levels. FIG. 3, discussed below, provides more detail regarding different member connection levels. Embodiments provide for the automated handling of invitations, for example, by a member executing an invitation function from the talent management platform interface and providing certain information regarding the invited individual, such as the individual's email address. The invitee subsequently may respond to the request and register as a member of the platform.

Embodiments provide that referral connections 203 may be comprised of platform referrals related to Member 1 201, such as referrals made directly by Member 1 or referrals made by members of Member 1's 201 network 202 (i.e., member connections 204) for a certain number of levels. In a non-limiting example provided in FIG. 2, Member 1 201 refers Candidate 1 207 for a position and, in response, Candidate 1 207 becomes linked to Member 1 201 as a referral made by Member 1 201 within the platform. Furthermore, embodiments provide that a member's network may consist of outside network connections 205, such as social networks the member has joined. For example, if Member 1 201 is a member of LinkedIn®, Member 1's 201 LinkedIn® accessible network of connections may be accessed as outside network connections 205 in Member 1's 201 network 202.

Embodiments are not limited to the types, number, and form of the networks 202-205 described in FIG. 2, as this figure depicts one non-restrictive embodiment and the networks provided therein are for illustrative purposes. According to embodiments, many different networks and sub-networks may be provided in multiple potential configurations. In addition, embodiments provide that there may be overlap between the different networks. As an illustrative and non-restrictive example, Member 1 201 may invite a member from his outside network connections 205, if the invitee accepts the invitation, then the invitee will become a member connection 204 of Member 1 201. Thus, the invitee will belong to Member 1's 201 outside network connections 205 and his member connections 204. Furthermore, if Member 1 201, then refers the invitee to a position within the platform, the invitee will additionally belong to Member 1's referral network 203.

Embodiments provide for a multi-level or tiered network. In a non-limiting example, a member network may be comprised of four levels, with the member himself occupying the first level. According to embodiments, if a first member directly interacts with a second member, the second member may become a member of the first member's network at the second level (the first level below the member himself). Non-limiting examples of interaction include inviting a member to join the network or referring an individual for a position. In addition, when a member in the first member's second level directly interacts with a third member, the third member may become a member of the first member's third level (and a member of the second member's second level). Embodiments provide that the addition of connections within a member network may be added accordingly, including to more remote levels.

Referring to FIG. 3, therein is depicted an example multi-level member network according to an embodiment. The talent management platform network 301 consists of platform members each associated with a member network 302, wherein each member network may be comprised of multiple levels. In the illustrative and non-restrictive example shown in FIG. 3, the member network has four levels 303-306, although more or less levels are possible. According to embodiments, the first level 303 consists of platform members 307. The remaining levels 303-306 consist of the network connections of the members 307 and indicate the relatedness between platform members. For example, if a first member invites an invitee to join the network and the invitee registers with the network, the invitee becomes a member of the first member's network at the second level 303 (the first level below the actual member). In addition, embodiments provide for multiple types of networks (not shown), such as a public platform network and one or more private networks each associated with a private entity.

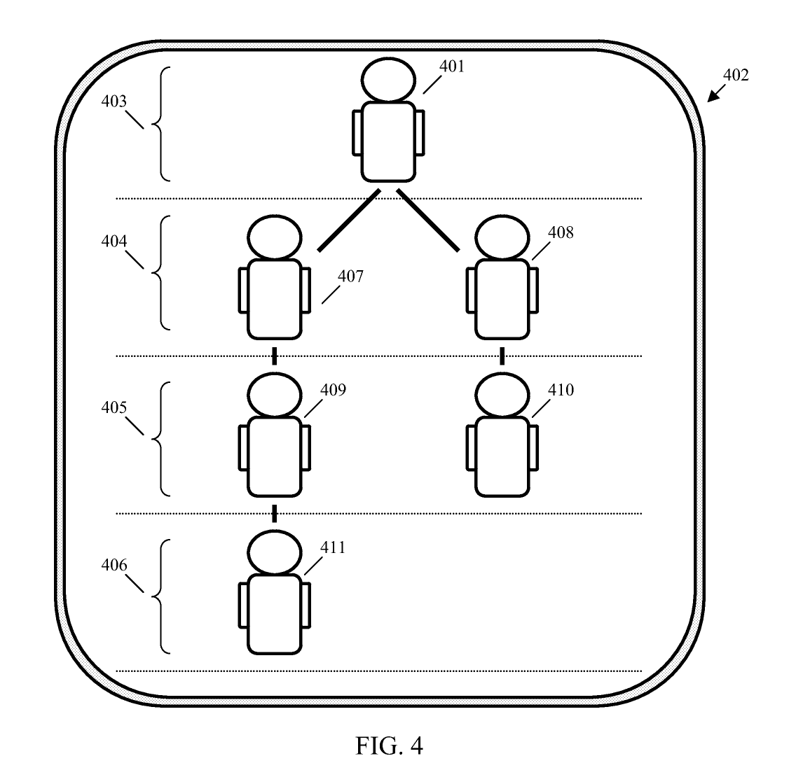

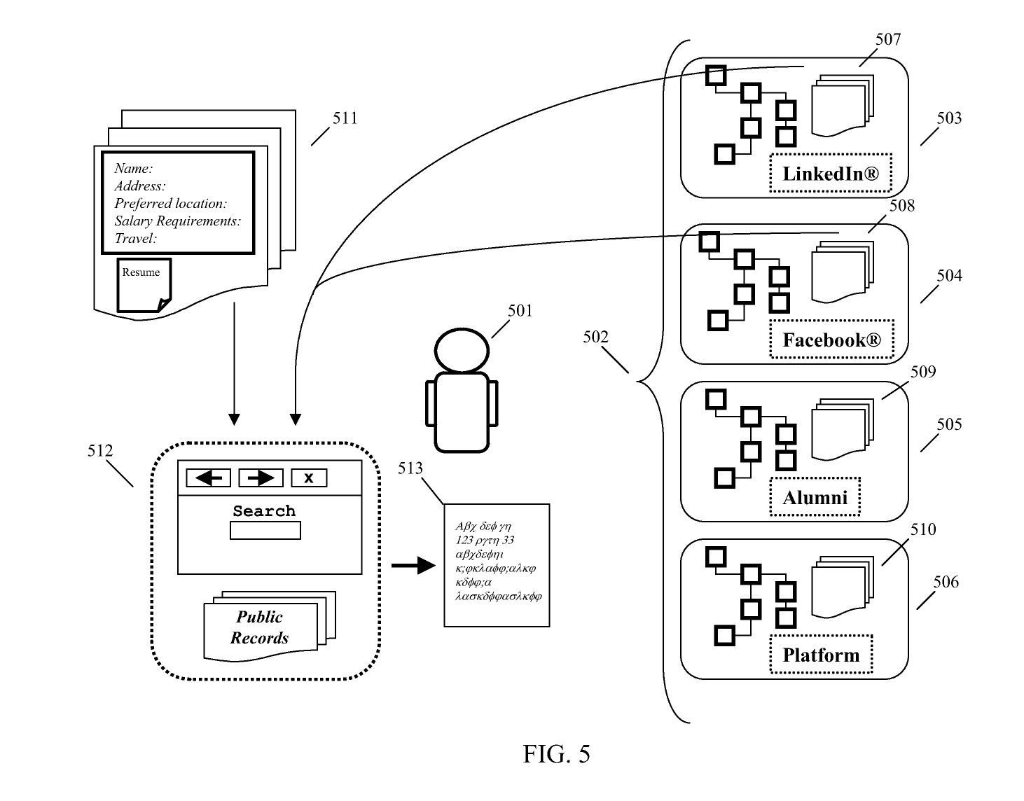

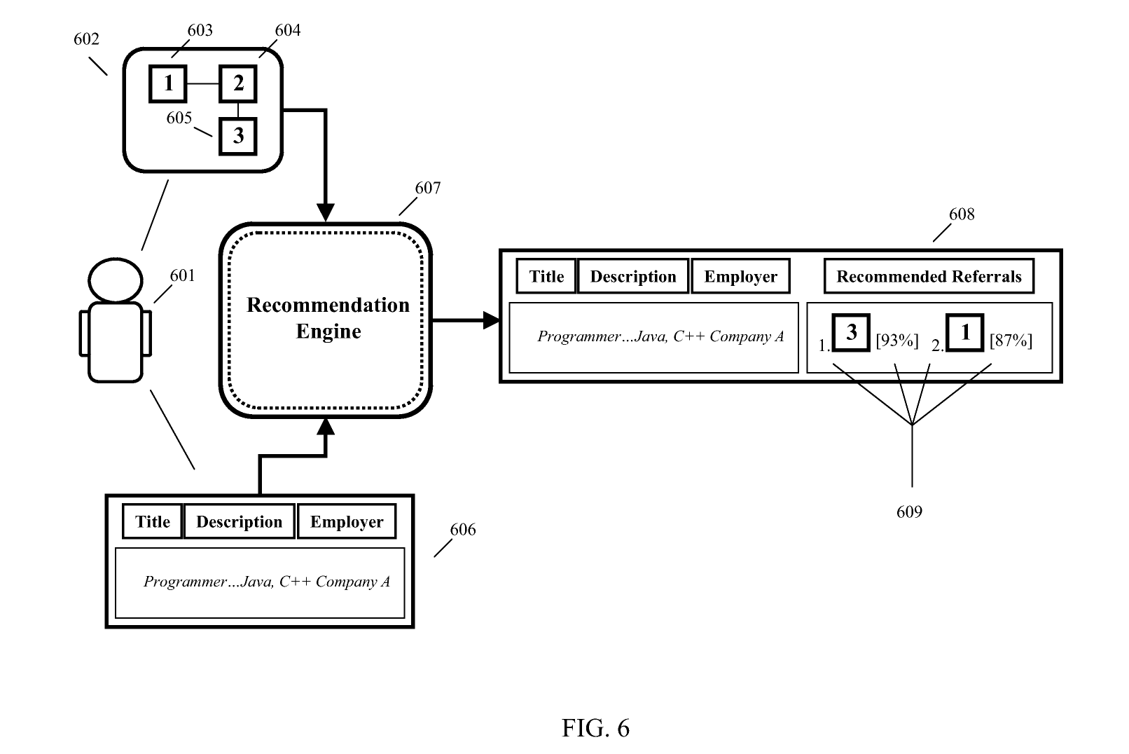

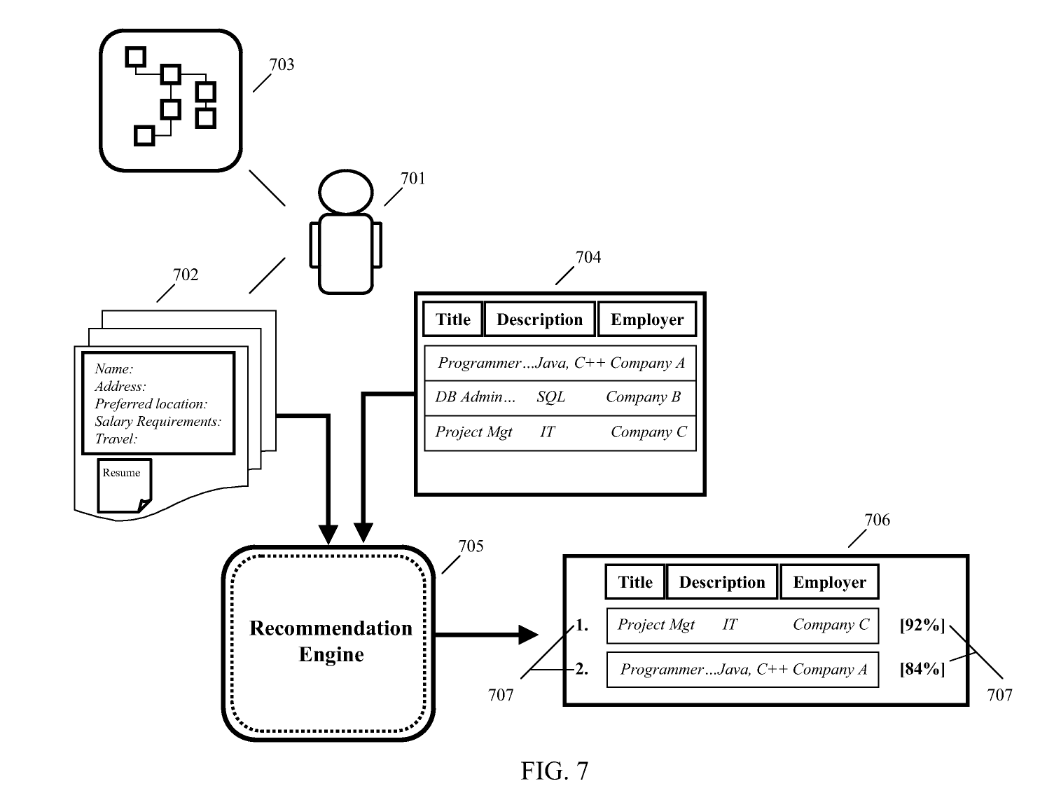

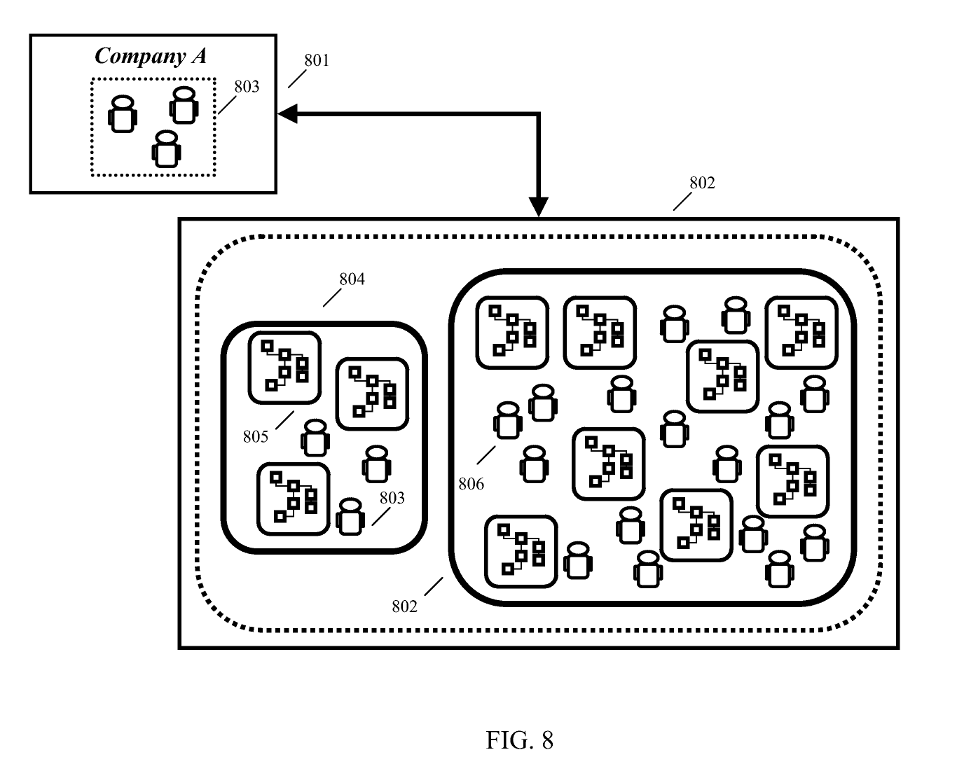

In FIG. 4, therein is provided an example member network according to one embodiment. Member 1 401 is associated with a network 402 comprised of four levels 403-406. The first level 403 consists only of Member 1 401, who may be considered the “parent” node of the network 402. The second level 404 consists of network members directly related to Member 1, such as through invitation or referral, and may be considered the “child” nodes of the network 402. A non-limiting example provides that if Member 1 401 invites Member 2 407 to join the talent management platform and Member 2 407 subsequently registers, then Member 2 407 becomes a member of Member 1's 401 network 402. Member 2 407 is in the second level 403 because Member 2 407 is directly related to Member 1 401 because Member 2 407 joined the platform responsive to an invitation from Member 1 401. In another non-limiting example, if Member 1 401 referred Member 3 408 to a position, Member 3 408 becomes connected within Member 1's 401 network 402 at the second level 403 because Member 3 408 is directly related to Member 1 401 through the referral.

The third 405 and fourth 406 levels are indirectly related to Member 1 401 through activity by members related to Member 1 401 at a higher level. A non-restrictive illustration provides that if Member 2 407 invites Member 4 409 to join the platform, when Member 4 409 registers, Member 4 409 becomes a connection in Member 1's 401 network 402 at the third level 405. Member 4 409 is indirectly related to Member 1 401 because Member 4 409 joined the network responsive to an invitation from a member related to Member 1 401 (i.e., Member 2 407). Another example provides that if Member 3 408 refers Member 5 410 for a position, Member 5 410 subsequently joins Member 1's 401 network 402 as a third level 405 member. Embodiments provide that the non-limiting example of network relationships may continue for one or more levels, such as level four 406 depicted in FIG. 3. For example, if Member 4 409 subsequently refers Member 6 411 for a position, Member 6 411 may be connected to Member 1 401 in level four 406 of the network 402.

In addition, embodiments provide that there may be overlap and/or shared connections between member networks. As a non-limiting example, Member 4 409 is a second level member of Member 2's 407 network (not shown) because Member 4 409 is directly related to Member 2 407 through Member 2's 407 invitation. In addition, Member 4 409 is also a member of Member 1's 401 network 402 at the third level 405. In addition, Member 5 410 is a second level connection in the network of Member 3 408 (not shown) and a third level 405 connection in the network 402 of Member 1 401.

Following registration and verification, embodiments provide that members may have access to job postings, which may include a frequently updated listing of job postings, such as daily updated job postings. A member, in response to reviewing the job postings, may search his or her personal network for individuals that may match the job postings. Embodiments may automate this search by automatically suggesting certain “friends” or other such individuals connected to the member that may qualify. Such automated suggesting may include, for example, comparing one or more metrics associated with the job posting to one or more metrics associated with the “friends” profiles in the member's personal network on the system (which again may be imported from other web sites). Thereafter, the member may make a referral.

Certain embodiments allow for better, faster and cheaper location of talent compared to prior talent management approaches, for example by leveraging member's use of social networking web sites. This is in part because according to certain embodiments, more people will be looking for the desired talent, for example, by employing contacts from other networks, including social networking sites. Members trying to identify qualified talent will be highly motivated to do so, because of both positive incentives (for example, remuneration) and negative incentives (decreased member ranking or credibility score), which may be accrued over time. Moreover, certain embodiments provide for more passive candidates to be identified, for example by leveraging interaction with other social networking web sites, with enforced credibility for members recommending these passive candidates. Certain embodiments will reduce costs associated with talent management by virtue of having less turnover. For example, as a result of more qualified candidates being identified and recommended in the first place due to a long term incentive approach according to embodiments.

A system according to embodiments may include one or more modules such as a candidate module, a jobs module, a credibility score module, a reference/referral module, a rewards module and a communications module. The system may communicate via the communications module with one or more remote devices such as a member's client device (for example, a personal computer or cell phone), one or more other web sites hosted by remote devices (for example, servers), such as social networking sites or other web sites (for example, customer sites or industry web sites).

According to embodiments, the candidate module may be configured to store one or more lists of potential candidates, for example, members within a particular member's network of contacts or other contacts as identified from other web sites. Embodiments provide that the jobs module may be configured to store one or more jobs listings, such as listings submitted by potential employers looking for qualified professional talent. Embodiments provide that the referral/reference module may be configured to store one or more lists of contacts actually referred or referenced by a member for particular positions. According to embodiments, the credibility score module may be configured to store one or more credibility scores associated with a member's performance within the system, for example, over specific period of time or over the duration of a user's membership. Embodiments provide for a rewards module that may be configured to store accounting details, such as one or more rewards awarded to a member for past services, account details, and the like. Each of the modules may be configured according to embodiments to execute computer program code configured to carry out specific acts or functions associated with storing, updating, or modifying, relevant information associated with the functionality of the module. Moreover, systems consistent with embodiments may contain more or less modules than illustrated, such as two modules being consolidated and/or additional modules being added for executing functionality consistent with the systems and methods described herein. Moreover, the modules may be linked or combined in a variety of ways depending upon the particular use contemplated.

Each of the modules may be configured according to embodiments to execute computer program code configured to carry out specific acts or functions associated with storing, updating, or modifying, relevant information associated with the functionality of the module. Moreover, systems consistent with embodiments may contain more or less modules than illustrated, such as two modules being consolidated and/or additional modules being added for executing functionality consistent with the systems and methods described herein. Moreover, the modules may be linked or combined in a variety of ways depending upon the particular use contemplated.

Embodiments may provide a member home page for display on a member's device, such as a personal computer, cell phone, or other computing device. The member home page may contain a variety of functional units for executing commands requesting that a system as described herein perform functions consistent with those described herein. For example, a member homepage may include, but is not limited to, providing an email client, a messaging client, an accounting client, and an invite/recruiting client. The invite/recruiting client may provide functionality supporting member recruiting activities, such as providing an option to invite a new member to join the system, invite an existing member to become part of the particular member's personal network, and conducting recruiting services such as selecting another member and referring them as a candidate for a job opening. The accounting client may provide accounting services to the member, such as linking a member account to that of a financial institution such that the rewards issued to a member can be direct deposited into the member's account at the given financial institution.

In addition, the member home page may include a variety of tabs that, in response to selection, provide a convenient display of member activities. A contacts tab may be provided that displays a list of contacts of the member upon selection. The contacts may include both member network contacts within the system as well as member contacts as derived from one or more external networks, such as social networking sites to which the member belongs. A jobs listing tab, may include, for example, a listing of jobs deposited within the system by clients looking to fill open positions. A rewards tab may include a listing of current, past or pending rewards a member has or can obtain via activities within the system. A credibility score tab may include the member's credibility score regarding referral activities within the system. A referrals tab may include a listing of referrals the member has made. A references tab may include a list of references the member has made.

Furthermore, the member's home page may include links to other web sites, such as other social networking web sites the member belongs to or web sites dedicated to certain professional organizations. The member's home page may also include a search function such that the member may search within the system for other pages, such as pages of other members, or for posted jobs. The member's homepage according to certain embodiments may display one or more member rankings or credibility scores, viewable by other members.

Embodiments may utilize one or more categories of the member information to implement a metric-based scoring (“ranking”) of the members. Key metrics used may include, but are not limited to, customer satisfaction with the member; number of members registered as a result of invitations sent by the member; utilization of the member's services; a member metric combining one or more member information categories, such as a member “batting average” (customer satisfaction combined with utilization), and/or a member “runs batted in” (customer satisfaction combined with number of recruits as compared with customer satisfaction combined with utilization); and the quality of the members referrals. Certain embodiments are configured to utilize a metrics based scoring system in order to ensure an aggressive quality assurance program regarding the members. In this way, those considering using one or more of the member's services can gain assurance that a member and referrals made by the member are of the utmost quality based on past performance.

As discussed herein, certain embodiments are configured to make the referral decision matter more than is usual to the member. In addition to receiving a reward, the member should be cognizant of the potential negative implications of making an inappropriate referral. Such negative implications may include, but are not limited to, a reduction in the member's rating, ranking, and/or credibility score within the system, which is visible to others.

Typical factors affecting the hiring decision are education, experience, and one or more references. Certain embodiments are configured to enable those making hiring decisions to have more confidence in the reference(s) submitted. Those making hiring decisions should take into account why they need a reference, how often they receive a negative one, and how they can verify the reference, and whether a member making a reference is accountable for the quality of the reference in some way. Accordingly, certain embodiments are configured to make references matter to those involved as acting as a reference or making a referral. By way of example, certain embodiments are configured to measure the quality of a particular reference's past performance in that capacity and make that past performance accessible to others considering reliance on the reference. Moreover, certain embodiments may correlate reward level to member ranking in this regard, thus tying compensation level to credibility within the system. Thus, certain embodiments are configured to score members over time such that an accountability is attached to the each reference, and that accountability (for example, ranking) follows the member over time.

Certain embodiments are configured to rank a reference utilizing detailed reference rankings as one or more member rankings, and associate them with members choosing to act as references. The detailed reference rankings take into account how accurate the reference's description was, how satisfied the recipient of the reference was, how responsive the reference was to submitted communications and questions, and the like, by implementing a user interface wherein a hiring manager can review the performance of the reference at a later time. Thus, certain embodiments are configured to provide quality assurance in the form of a credibility index or score for references, such as reflected by a member's customer satisfaction score. Such visibility and accountability within the system will make decisions by hiring managers easier inasmuch as they will have some qualitative way of determining how reliable a particular reference is likely to be. Moreover, long term incentives may attach to members acting as references. For example, certain embodiments are configured to remove recruiter privileges from a member if his or her credibility index drops below a certain predetermined threshold value. In another example, embodiments may provide enhanced job listings, such as the ability to view job listings before other members, to members with a score above a certain threshold.

According to embodiments the incentive rewards may be based on levels. As a non-limiting example, a member may receive a first level reward for a qualifying direct referral; a member may receive a second level reward for a qualifying indirect referral; and a member may receive a third level reward for a qualifying remotely connected referral from his or her network. According to certain embodiments, a first level reward may be of higher value than a second level reward, a second level reward may be higher than a third level reward, and so on. Referring to FIG. 4, a first level reward may involve members in the second level 404 of Member 1's 401 network 402; second level rewards may involve members in the third level 405 of the network 402; and third level rewards may involve members in the fourth level 406 of the network 402.

A talent management platform according to embodiments is configured to obtain information from members. According to embodiments, such information includes, but is not limited to, networks, connections, or online communities associated with the member, resume information, talent management platform profile information, and other accessible personal information. The terms networks, connections, and online communities are collectively referred to as “member networks” within this specification, unless specified otherwise or discussed individually.

In FIG. 5, therein is provided an example of information available to the talent management platform according to an embodiment. A platform member 501 belongs to certain social graphs 502, non-limiting examples provided in FIG. 5 include the social networks LinkedIn® 503 and Facebook® 504, an alumni network 505, and the platform network 506. The member networks 502 each have their own set of data 507, 508, 509, 510 including network data, connections, and profile data of the connections. As shown in FIG. 5, information may also be available through profile information supplied to the platform 511. Such information may include name and address information, a resume, and other personal information, such as preferred geographical region, desired position, willingness to travel, and salary requirement information. FIG. 5 also provides that enhanced information 513 may be obtained through information gathering and analysis 512, which includes generating inferences or assumptions from the available information, searching for publicly available information, such as public government records and information available online, and generating a profile for a specific member or candidate based on the located information based on available network data 507-511.

Embodiments provide for a recommendation engine configured to locate and recommend high quality candidates for positions. According to embodiments, the recommendation engine is configured to access social graphs associated with platform members and their connections, and to obtain information available from the social graphs, such as profile and connection information. Embodiments may analyze the available information associated with platform members, connected social graphs, and profile information of social graph members connected to platform members and generate certain assumptions, inferences, and related information. Embodiments provide that the assumptions, inferences, and related information may be obtained through multiple methods, including, but not limited to, being supplied by the subject (e.g., supplied through a questionnaire or profile form), through inferences generated based on known information, and by using known information to search and locate subjective information from other information sources (e.g., publicly available information sources, Internet searches). Embodiments provide that the recommendation engine may analyze member networks and recommend potential candidates located therein for open positions. In addition, embodiments provide that the recommendation engine is configured to recommend jobs to talent management platform members. According to embodiments, the recommendation engine may obtain member information, analyze available job listings, and provide recommendations of available jobs that fit the member information.

Embodiments are configured to utilize social graphs including, but not limited to, the talent management platform network, social networks, alumni networks, and professional networks. For example, a talent management platform according to embodiments may require that members provide or join the platform using social network credentials. Embodiments are configured to obtain information from the member networks for use in determining candidate recommendations, including, but not limited to, member profile information, member connections, and profile information from the member's connections. According to existing technology, the API's of certain member networks, such as the social networks LinkedIn® and Facebook®, have been made publicly available. As such, embodiments may access the API's of social networks used by members and obtain their connections within said social networks. However, embodiments are not limited to accessing member networks through available API's, as any applicable method for obtaining information from member networks may be applied.

Referring to FIG. 6, therein is depicted an example recommendation engine accessing a member network and providing position referrals according to an embodiment. A talent management platform member 601 is a member of a social network 602 with three social network connections 603-605. The member 601 selects a job listing 606 posted on the talent management platform, resulting in the recommendation engine 607 accessing the social network connections 603-605. The recommendation engine 607 analyzes information associated with the social network connections 603-605, such as profile information, based on certain candidate factors obtained from the job listing 606 and provides a set of recommendations 608 selected from the social network connections 603-605. In the example provided in FIG. 6, the recommendations are ranked and scored 609 according to how well they fit the job listing 606.

Embodiments provide that a member may interact with the talent management platform in multiple ways, for example, as a job seeker or to refer candidates. Referring to FIG. 7, therein is depicted an example of a member interacting with the talent management platform according to an embodiment. A member 701 has both profile information 702 and connections to member networks 703. The member 701 may select to access the available job listings 504 and search for a job for himself. The recommendation engine 705 accesses the member profile information 702 and accesses the data associated with the available job listings 704 and generates a set of recommended jobs 706. According to embodiments, the recommendation engine 705 may rank and score 707 the recommended jobs 706 for the member 701 according to certain criteria, such as how well they fit the member profile information, member preferences, location, or whether the position is higher than the member's current position. After reviewing the recommended jobs 706, the member 701 may select to apply for one or more of the jobs.

Embodiments provide for multiple categories of networks within the talent management platform. According to embodiments, one category consists of private networks that are comprised of members associated with one or more private entities and these members' associated networks. In addition, embodiments provide for public networks comprised of members not affiliated with a private entity.

Referring to FIG. 8, therein is provided an example of private and public networks according to an embodiment. Company A 801 enters into an association with the talent management platform 802. The employees 803 of Company A 801 are registered as private members within the platform 802 through the generation of a Company A private network 804 consisting of the Company A employees 803 and social graphs 805 associated with the employees 805, including, but not limited to, social networks and professional networks. Embodiments provide that private networks, such as the Company A private network 804 depicted in FIG. 8, are only accessible to the private entity associated with the network and its members. As such, only Company A 801 may access the Company A private network 804.

Also illustrated in FIG. 8 are public members 806, who are platform 602 members not affiliated with a private entity, such as Company A 801. The public members 806 form a public network 807 within the platform. According to embodiments, private entities may only access their own private networks and may not access the public network 807 unless an arrangement (e.g., a fee, subscription, etc.) is created between the private entity and the talent management platform. In addition, access to a private network is not available to the public platform membership or to other private entities, because access to a specific private network is limited to the specific private entity associated with the network, unless access is otherwise provided for, such as in a sharing or exchange agreement.

Referring to FIG. 9, therein is depicted an example of recommendation engine operation with a private network according to an embodiment. A private entity 901 has a human resources management system (HRMS) 903 that contains position data 904 and employee data 905. The employee data 905 is accessed by the talent management platform 902 to create a private network 906 and the position data 904 is accessed to create private entity job listings 907. The private network 906 consists of employees of the private entity, who are registered as private members within the platform, and their associated social graphs, such as their LinkedIn® connections. The recommendation engine 908 accesses and analyzes the job listings 907 and the private network 906 and generates candidate recommendations 909 for the job listings 907. In addition, if an arrangement is made between the private entity 901 and the platform 902, the recommendation engine may additionally access and analyze the platform public network (not shown) when generating candidate recommendations 909.

Referring to FIG. 10, therein is depicted an example of recommendation operation with a staffing firm entity according to an embodiment. A staffing firm 1001 has a repository of jobs 1003 it is attempting to fill for clients. The talent management platform 1002 accesses the jobs repository 1003, and this information along with the public network 1004 are accessed by the recommendation engine 1005. The recommendation engine 1005 analyzes the jobs repository 1003 information in relation to information from the public network 1004, and generates candidate recommendations 1006 for the jobs listed in the jobs repository 1003.

Embodiments are configured to generate platform networks comprised of different levels. In addition, certain embodiments may grant differential access to platform networks. A non-limiting example provides that a platform network may have a first layer comprised of platform members, a second layer of LinkedIn® connections to platform members, a third layer of Facebook® connections to platform members, and a fourth layer comprising professional network connections, such as networks affiliated with certain industries and professions (e.g., electrical engineering, accounting). According to embodiments, the talent management platform may have certain arrangements with entities wherein the entities may only access certain platform network layers, unless another arrangement (e.g., fee, subscription, etc.) is created between an entity and the platform.

As described above, embodiments may access jobs from multiple sources, such as employer job listings, private entity job listings, and staffing agency job listings. In addition, embodiments provide that the talent management platform may locate and list jobs from other sources, including the Internet, such as from for-profit job boards (e.g., Monster®), university job boards, government job postings, company web sites, and any other available source of job listings.

A recommendation engine according to embodiments processes multiple data inputs when generating candidate or job recommendations. For example, embodiments provide for job, member, and member network information. In addition, embodiments are configured to accept and analyze other forms of information, such as member or candidate preference information. According to embodiments, preference information may involve member preferences, such as wanting to work at a smaller, more entrepreneurial firm in favor of a large firm, wanting to work with a particular technology, or preferring jobs that represent an increase in position or pay in favor of positions involving a more lateral move. In addition, embodiments may take an employer's corporate culture into account, including, but not limited to, whether the culture is more flexible, whether it provides for clear paths of advancement, or the amount of creative freedom allowed by employees.

In one non-restrictive illustration, a member seeking to refer candidates for a job may specify that he does not want one or more connections in his network to be recommended for all jobs or just specific jobs. For example, a member may know that a member network connection is not interested in a new job or that the candidate may only be interested in database administrator positions. In another example, a member looking for a job may specify that he is only interested in programming jobs in a particular language, although he may be qualified for a broad range of programming jobs.

Referring to FIG. 11, it will be readily understood that certain embodiments can be implemented using any of a wide variety of devices or combinations of devices. An example device that may be used in implementing one or more embodiments includes a computing device in the form of a computer 1110.

Components of computer 1110 may include, but are not limited to, a processing unit 1120, a system memory 1130, and a system bus 1122 that couples various system components including the system memory 1130 to the processing unit 1120. The computer 1110 may include or have access to a variety of computer readable media. The system memory 1130 may include computer readable storage media in the form of volatile and/or nonvolatile memory such as read only memory (ROM) and/or random access memory (RAM). By way of example, and not limitation, system memory 1130 may also include an operating system, application programs, other program modules, and program data.

A user can interface with (for example, enter commands and information) the computer 1110 through input devices 1140. A monitor or other type of device can also be connected to the system bus 1122 via an interface, such as an output interface 1150. In addition to a monitor, computers may also include other peripheral output devices. The computer 1110 may operate in a networked or distributed environment using logical connections to one or more other remote computers or databases. The logical connections may include a network, such local area network (LAN) or a wide area network (WAN), but may also include other networks/buses.

It should be noted as well that certain embodiments may be implemented as a system, method or computer program product. Accordingly, aspects may take the form of an entirely hardware embodiment, an entirely software embodiment (including firmware, resident software, micro-code, et cetera) or an embodiment combining software and hardware aspects that may all generally be referred to herein as a “circuit,” “module” or “system.” Furthermore, aspects may take the form of a computer program product embodied in one or more computer readable medium(s) having computer readable program code embodied therewith.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, et cetera, or any suitable combination of the foregoing.

Computer program code for carrying out operations for various aspects may be written in any combination of one or more programming languages, including an object oriented programming language such as Java™, Smalltalk, C++ or the like and conventional procedural programming languages, such as the “C” programming language or similar programming languages. The program code may execute entirely on a single computer (device), partly on a single computer, as a stand-alone software package, partly on single computer and partly on a remote computer or entirely on a remote computer or server. In the latter scenario, the remote computer may be connected to another computer through any type of network, including a local area network (LAN) or a wide area network (WAN), or the connection may be made for example through the Internet using an Internet Service Provider.

Aspects are described herein with reference to flowchart illustrations and/or block diagrams of methods, apparatuses (systems) and computer program products according to example embodiments. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Although illustrated example embodiments have been described herein with reference to the accompanying drawings, it is to be understood that embodiments are not limited to those precise example embodiments, and that various other changes and modifications may be affected therein by one skilled in the art without departing from the scope or spirit of the disclosure.

What is claimed is:

1. A system comprising:
one or more processors;
a system memory operatively coupled to the one or more processors; and
one or more professional talent management modules communicatively coupled to the system memory, wherein the one or more professional talent management modules are adapted to:
register one or more system members arranged in one or more system networks, each of the one or more members belonging to one or more external networks;
obtain network profile information from connections within the one or more system networks and the one or more external networks;
list one or more positions comprising position information; and
configure a recommendation engine to generate one or more referrals for the one or more positions by applying the network profile information to the position information.

2. The system according to claim 1, wherein the one or more external networks comprise one or more social networks.

3. The system according to claim 2, wherein registering one or more members comprises obtaining credentials for the one or more social networks.

4. The system according to claim 2, wherein the network profile information comprises social network profile information of social network members connected to a system member.

5. The system according to claim 1, wherein the one or more system networks comprise a public system network and one or more private system networks.

6. The system according to claim 5, wherein obtaining network profile information comprises obtaining information from the public system network and omitting information from the one or more private system networks.

7. The system according to claim 5, wherein obtaining network profile information comprises obtaining information from one of the one or more private system networks and omitting information from the public system network and a remainder of the one or more private system networks.

8. The system according to claim 1, wherein the network information is used to gather related publicly available information.

9. The system according to claim 8, wherein the recommendation engine generates one or more position decisions by applying the publicly available information to the position information.

10. The system according to claim 3, wherein the one or more professional talent management modules are further adapted to:
access the one or more social networks associated with a member using the credentials supplied by the member;
access social network profiles of social network connections connected to the member within the one or more social networks;
analyze the social network profiles of each social network connection to generate inferences based on information contained within the social network profiles, the inferences relating to employment patterns and professional fitness of the social network connection; and
obtain publicly available information related to each social network connection by performing an Internet and public information search based on information contained within the social network profiles;
wherein the recommendation engine utilizes the inferences and the publicly available information to generate the one or more referrals.

11. A method comprising:
registering one or more system members arranged in one or more system networks, each of the one or more members belonging to one or more external networks;
obtaining network profile information from connections within the one or more system networks and the one or more external networks;
listing one or more positions comprising position information; and
configuring a recommendation engine to generate one or more referrals for the one or more positions by applying the network profile information to the position information.

12. The method according to claim 11, wherein the one or more external networks comprise one or more social networks.

13. The method according to claim 12, wherein registering one or more members comprises obtaining credentials for the one or more social networks.

14. The method according to claim 12, wherein the network profile information comprises social network profile information of social network members connected to a system member.

15. The method according to claim 11, wherein the one or more system networks comprise a public system network and one or more private system networks.

16. The method according to claim 15, wherein obtaining network profile information comprises obtaining information from the public system network and omitting information from the one or more private system networks.

17. The method according to claim 15, wherein obtaining network profile information comprises obtaining information from one of the one or more private system networks and omitting information from the public system network and a remainder of the one or more private system networks.

18. The method according to claim 11, wherein the network information is used to gather related publicly available information.

19. The method according to claim 18, wherein the recommendation engine generates one or more position decisions by applying the publicly available information to the position information.

20. A computer program product comprising:
a computer readable storage medium having computer readable program code embodied therewith, the computer readable program code comprising:
computer readable program code configured to register one or more system members arranged in one or more system networks, each of the one or more members belonging to one or more external networks;
computer readable program code configured to obtain network profile information from connections within the one or more system networks and the one or more external networks;
computer readable program code configured to list one or more positions comprising position information; and
computer readable program code configured to configure a recommendation engine to generate one or more referrals for the one or more positions by applying the network profile information to the position information.
